(19) United States
(12) Patent Application Publication
(10) Pub. No.: US 2017/0052552 A1
(43) Pub. Date: Feb. 23, 2017

(54) SINGLE LDO FOR MULTIPLE VOLTAGE DOMAINS

(71) Applicant: QUALCOMM Incorporated, San Diego, CA (US)

(72) Inventors: Farsheed Mahmoudi, San Diego, CA (US); Sassan Shahrokhinia, San Diego, CA (US); James Thomas Doyle, Carlsbad, CA (US)

(21) Appl. No.: 14/831,874

(22) Filed: Aug. 21, 2015

(51) Int. Cl. G05F 1/575

(52) U.S. Cl. CPC G05F 1/575

(57) ABSTRACT

Low dropout (LDO) regulators are described herein for providing regulated voltages for multiple voltage domains. In one embodiment, a voltage regulator comprises a plurality of pass transistors, each of the plurality of pass transistors being coupled between an input supply rail and a respective one of a plurality of regulator outputs. The voltage regulator also comprises a plurality of averaging resistors configured to average a plurality of feedback voltages to generate an average feedback voltage, wherein each of the plurality of feedback voltages provides voltage feedback for a respective one of the plurality of regulator outputs. The voltage regular further comprises an amplifier having a first input coupled to the average feedback voltage, and a second input coupled to a reference voltage, wherein the amplifier is configured to drive the plurality of pass transistors in a direction that reduces a difference between the reference voltage and the average feedback voltage.

### BACKGROUND

Field

Aspects of the present disclosure relate generally to voltage regulators, and more particularly, to a low-dropout (LDO) regulator for multiple voltage domains.

Background

Voltage regulators are used in a variety of systems to provide regulated voltages to power circuits in the systems. A commonly used voltage regulator is a low-dropout (LDO) regulator. An LDO regulator may be used to provide a steady regulated voltage to power a circuit from a noisy input supply voltage. An LDO regulator typically comprises a pass transistor and an amplifier coupled in a feedback loop to maintain an approximately constant output voltage based on a stable reference voltage.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

According to an aspect, a voltage regulator is described herein. The voltage regulator comprises a plurality of pass transistors, each of the plurality of pass transistors being coupled between an input supply rail and a respective one of a plurality of regulator outputs. The voltage regulator also comprises a plurality of averaging resistors configured to average a plurality of feedback voltages to generate an average feedback voltage, wherein each of the plurality of feedback voltages provides voltage feedback for a respective one of the plurality of regulator outputs. The voltage regulator further comprises an amplifier having a first input coupled to the average feedback voltage, and a second input coupled to a reference voltage, wherein the amplifier is configured to drive the plurality of pass transistors in a direction that reduces a difference between the reference voltage and the average feedback voltage.

A second aspect relates to a method for voltage regulation. The method comprises providing a plurality of output voltages from an input supply voltage using respective pass transistors. The method also comprises averaging a plurality of feedback voltages to generate an average feedback voltage, wherein each of the plurality of feedback voltages provides feedback for a respective one of the plurality of output voltages. The method further comprises comparing the average feedback voltage with a reference voltage, and driving the pass transistors in a direction that reduces a difference between the reference voltage and the average feedback voltage.

A third aspect relates to an apparatus for voltage regulation. The apparatus comprises means for providing a plurality of output voltages from an input supply voltage. The apparatus also comprises means for averaging a plurality of feedback voltages to generate an average feedback voltage, wherein each of the plurality of feedback voltages provides feedback for a respective one of the plurality of output voltages. The apparatus further comprises means for comparing the average feedback voltage with a reference voltage, and means for driving the means for providing the plurality of output voltages in a direction that reduces a difference between the reference voltage and the average feedback voltage.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 shows an example of a low-dropout (LDO) regulator for one voltage domain according to certain aspects of the present disclosure.

FIG. 2 shows an example of an LDO regulator for multiple voltage domains according to certain aspects of the present disclosure.

FIG. 3 shows an example of an LDO regulator comprising feedback capacitors according to certain aspects of the present disclosure.

FIG. 4 shows an example of an LDO regulator comprising gate resistors according to certain aspects of the present disclosure.

FIG. 5 shows an example of an LDO regulator with a transistor gate coupled directly to an amplifier output according to certain aspects of the present disclosure.

FIG. 6 shows an example of an LDO regulator comprising voltage-divider switches according to certain aspects of the present disclosure.

FIG. 7 shows an exemplary system in which an LDO regulator according to certain aspects of the present disclosure may be used.

FIG. 8 is a flowchart showing a method for voltage regulation according to certain aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

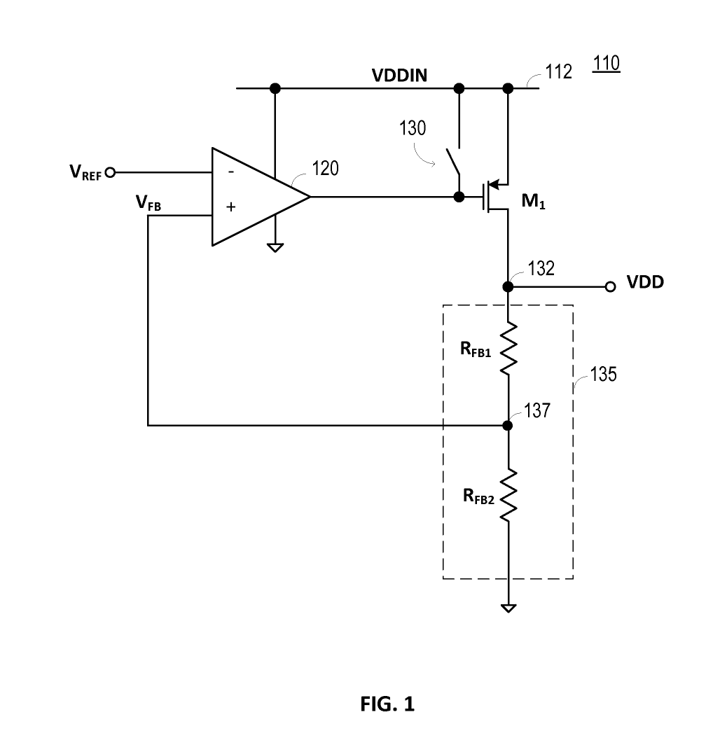

FIG. 1 shows an example of a low-dropout (LDO) regulator 110 according to certain aspects of the present disclosure. The LDO regulator 110 is configured to provide a regulated output voltage VDD from an input supply voltage VDDIN, as discussed further below. The LDO regulator 110 comprises an operational amplifier 120, a pass transistor M₁, a gate switch 130, and a voltage divider 135. The voltage divider 135 comprises resistors R_{FB1} and R_{FB2} coupled in series. In the example in FIG. 1, the pass transistor M₁ is a p-type metal-oxide-semiconductor (PMOS) transistor.

The pass transistor M₁ has a source coupled to the input supply voltage VDDIN at supply rail 112, a gate coupled to the output of the amplifier 120, and a drain coupled to the output 132 of the LDO regulator 110. The gate switch 130 is coupled between the input supply voltage VDDIN and the gate of the pass transistor M₁. The voltage divider 135 is coupled between the output 132 of the LDO and ground. The amplifier 120 has one input coupled to a reference voltage V_{REF} and another input coupled to a feedback voltage V_{FB} taken from a node 137 located between the resistors R_{FB1} and R_{FB2} of the voltage divider 135. The reference voltage V_{REF} may be provided, for example, by a bandgap reference circuit or another stable voltage source.

In operation, output of the regulated VDD is enabled by opening the switch 130 (i.e., turning off the switch 130). In this case, the amplifier 120 drives the gate of the pass transistor M₁ in a direction that reduces the difference between V_{REF} and V_{FB} at the inputs of the amplifier 120. In other words, the amplifier 120 drives the gate of the pass transistor M₁ in a direction that forces V_{FB} to be approximately equal to V_{REF}. This feedback causes the regulated output voltage VDD to be approximately equal to:

$$VDD = ( 1 + \frac{{R}_{FB 1}}{{R}_{FB 2}} ) \cdot {V}_{REF} \qquad ( 1 )$$

where R_{FB1} and R_{FB2} in equation (1) are the resistances of resistors R_{FB1} and R_{FB2}, respectively. As shown in equation (1), the regulated output voltage VDD may be set to a desired voltage by setting the ratio of the resistances of resistors R_{FB1} and R_{FB2} accordingly. The regulated output voltage VDD may be provided to a circuit (not shown) coupled to the output 132 of the LDO regulator 110 to power the circuit.

Output of the regulated output voltage VDD is disabled by closing the switch 130 (i.e., turning on the switch 130). In this case, the switch 130 pulls the gate of the pass transistor M₁ to VDDIN, which turns off the pass transistor M₁. Because the pass transistor M₁ is turned off, the output 132 of the LDO regulator 110 is decoupled from VDDIN. As a result, capacitors in the circuit coupled to the output 132 may discharge through the voltage divider 135 and/or discharge due to current leakage in the circuit. This may cause the voltage at the output 132 of the LDO regulator 110 to collapse to ground.

In some applications, it may be desirable to provide multiple voltage domains to power different circuits on a chip. Each voltage domain may have the same voltage or different voltage. The voltage domains may be independently collapsible so that each circuit can be independently powered on and off. It may also be desirable to regulate the voltage of each voltage domain, for example, to provide each voltage domain with a steady voltage.

One approach to provide multiple voltage domains is to provide a separate LDO regulator for each voltage domain. However, this approach requires multiple LDO regulators, which increases power consumption. The increase in power consumption may be unacceptable for low-power applications.

In another approach, each voltage domain may be selectively coupled to the output of the same LDO regulator through a respective head switch. This allows the voltage domains to be independently collapsed by independently controlling the head switches of the voltage domains. However, a drawback of this approach is that the resistor-current (IR) drops across the head switches increase power consumption and reduce the voltage supplied to the circuits of the voltage domains.

Accordingly, methods and systems for providing multiple voltage domains that avoid one or more of the drawbacks discussed above may be desirable.

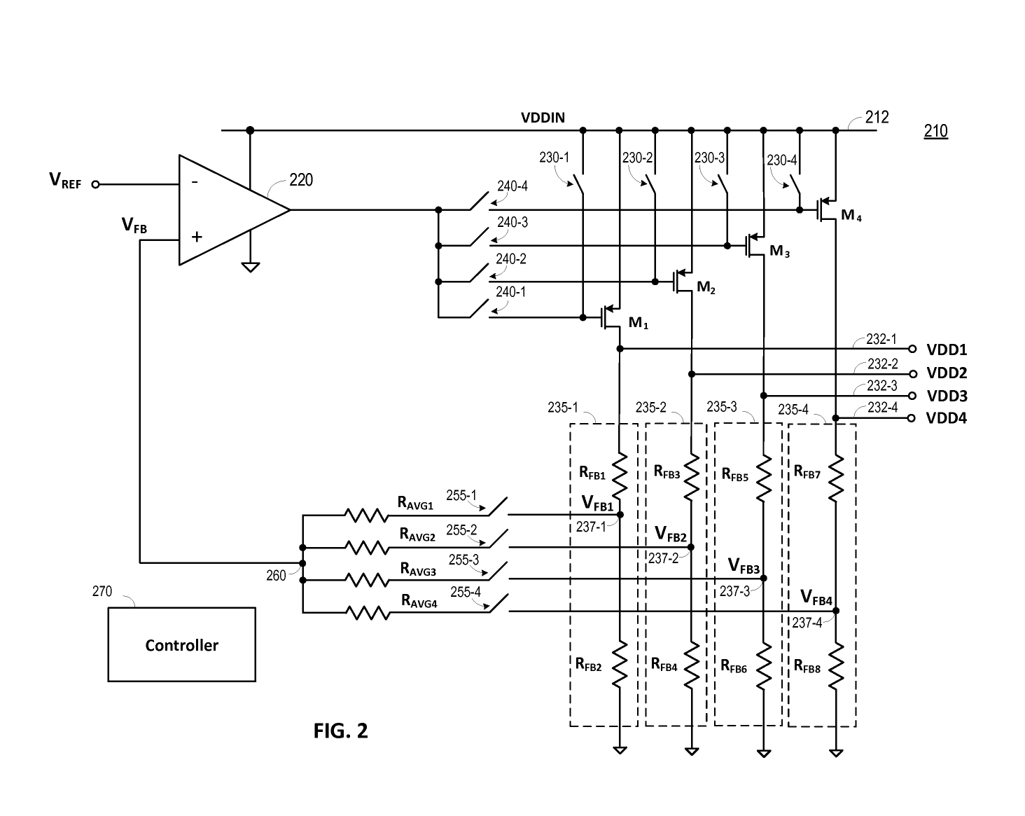

FIG. 2 shows an LDO regulator 210 according to certain aspects of the present disclosure. The LDO regulator 210 is configured to provide regulated voltages VDD1 to VDD4 for multiple voltage domains from an input supply voltage VDDIN. By using one LDO regulator 210 for multiple voltage domains, power consumption is significantly reduced compared with using a separate LDO regulator for each voltage domain. Further, as discussed further below, the LDO regulator 210 does not require head switches to independently enable/disable the voltage domains, thereby reducing IR drops between the LDO outputs and the circuits being powered by the LDO regulator 210.

The LDO regulator 210 comprises an operational amplifier 220, a plurality of pass transistor M₁ to M₄, a first plurality of gate switches 230-1 to 230-4, and a second plurality of gate switches 240-1 to 240-4. Each of the pass transistors M₁ to M₄ has a source coupled to the input supply voltage VDDIN at supply rail 212, and a drain coupled to a respective one of the LDO outputs 232-1 to 232-4. Each of the first plurality of gate switches 230-1 to 230-4 is coupled between VDDIN and a gate of a respective one of the pass transistors M₁ to M₄. Each of the second plurality of gate switches 240-1 to 240-4 is coupled between the output of the amplifier 220 and the gate of a respective one of the pass transistors M₁ to M₄.

The LDO regulator 210 further comprises a plurality of voltage dividers 235-1 to 235-4, where each of the voltage dividers 235-1 to 235-4 is coupled between a respective one of the LDO outputs 232-1 to 232-4 and ground. Each of the voltage dividers comprises a pair of resistors coupled in series. More particularly, a first one of the voltage dividers 235-1 comprises resistors R_{FB1} and R_{FB2} coupled in series, a second one of the voltage dividers 235-2 comprises resistors R_{FB3} and R_{FB4} coupled in series, a third one of the voltage dividers 235-3 comprises resistors R_{FB5} and R_{FB6} coupled in series, and a fourth one of the voltage dividers 235-4 comprises resistors R_{FB7} and R_{FB8} coupled in series. The resistors R_{FB1} to R_{FB8} may comprise polysilicon resistors, metal resistors, or other types of resisters. Each of the voltage dividers 235-1 to 235-4 divides the voltage at the respective LDO output 232-1 to 232-4 to generate a divided voltage at a respective feedback node 237-1 to 237-4 located between the respective resistors. The divided voltage at each feedback node 237-1 to 237-4 provides a respective feedback voltage V_{FB1} to V_{FB4}, as shown in FIG. 2.

The LDO regulator 210 further comprises a plurality of feedback switches 255-1 to 255-4 and a plurality of averaging resistors R_{AVG1} and R_{AVG4}. Each of the feedback switches 255-1 to 255-4 is coupled at one end to a respective one of the feedback nodes 237-1 to 237-4, and at the other end to a respective one of the averaging resistors R_{AVG1} and R_{AVG4}. Each of the averaging resistors R_{AVG1} and R_{AVG4} is coupled at one end to the respective one of the feedback switches 235-1 to 235-4, and at the other end to a common feedback node 260. The common feedback node 260 is coupled to a first input of the amplifier 220. As discussed further below, the averaging resistors R_{AVG1} and R_{AVG4} are used to average the feedback voltages V_{FB1} to V_{FB4}, in which the resulting average feedback voltage V_{FB} is input to the first input of the amplifier 220. A second input of the amplifier 220 is coupled to a reference voltage V_{REF}, which may be provided by a bandgap reference circuit or another stable voltage source.

As discussed above, the LDO regulator 210 is configured to provide regulated voltages VDD1 to VDD4 for four different voltage domains from the input supply voltage VDDIN. Voltage domain VDD1 corresponds to switches 230-1, 240-1 and 255-1, pass transistor M₁, voltage divider 235-1, and averaging resistor R_{AVG1} of the LDO regulator 210. Voltage domain VDD2 corresponds to switches 230-2, 240-2 and 255-2, pass transistor M₂, voltage divider 235-2, and averaging resistor R_{AVG2} of the LDO regulator 210. Voltage domain VDD3 corresponds to switches 230-3, 240-3 and 255-3, pass transistor M₃, voltage divider 235-3, and averaging resistor R_{AVG3} of the LDO regulator 210. Finally, voltage domain VDD4 corresponds to switches 230-4, 240-4 and 255-4, pass transistor M₄, voltage divider 235-4, and averaging resistor R_{AVG4} of the LDO regulator 210. Each of the voltage domains may be used to power a respective circuit, as discussed further below.

The switches 230-1 to 230-4, 240-1 to 240-4 and 255-1 to 255-4 allow a controller 270 to independently enable/disable the voltage domains. To enable a voltage domain, the controller 270 turns off (opens) the respective one of the first plurality of gate switches 230-1 to 230-4, turns on (closes) the respective one of the second plurality of gate switches 240-1 to 240-4, and turns on (closes) the respective one of the feedback switch 255-1 to 255-4. To disable a voltage domain, the controller 270 turns on (closes) the respective one of the first plurality of gate switches 230-1 to 230-4, turns off (opens) the respective one of the second plurality of gate switches 240-1 to 240-4, and turns off (opens) the respective one of the feedback switches 255-1 to 255-4. For ease of illustration, the individual connections between the controller 270 and the switches are not explicitly shown in FIG. 2.

When the controller 270 enables all four voltage domains, the feedback voltages V_{FB1} to V_{FB4} of all of the voltage domains contribute to the average feedback voltage V_{FB} generated at the common feedback node 260. The amplifier 220 adjusts its output voltage (which drives all four pass transistors M₁ to M₄) in a direction that reduces the differences between V_{REF} and the average feedback voltage V_{FB} at the inputs of the amplifier 220. In other words, the amplifier 220 drives the gates of the pass transistors M₁ to M₄ in a direction that forces the average feedback voltage V_{FB} to be approximately equal to V_{REF}. In this case, the average feedback voltage V_{FB} may be given by:

$${V}_{FB} = \frac{{R}_{AVG 1} \cdot {V}_{FB 1} + {R}_{AVG 2} \cdot {V}_{FB 2} + {R}_{AVG 3} \cdot {V}_{FB 3} + {R}_{AVG 4} \cdot {V}_{FB 4}}{{R}_{AVG 1} + {R}_{AVG 2} + {R}_{AVG 3} + {R}_{AVG 4}} \qquad ( 2 )$$

where R_{AVG1} to R_{AVG4} in equation (2) are the resistances of averaging resistors R_{AVG1} and R_{AVG4}, respectively. The feedback voltages V_{FB1} to V_{FB4} may be weighted equally by making the resistances of the averaging resistors R_{AVG1} and R_{AVG4} approximately equal. Alternatively, the feedback voltages V_{FB1} to V_{FB4} may be weighted differently by making the resistances of the averaging resistors R_{AVG1} and R_{AVG4} different, as discussed further below.

Each voltage domain may be set to a desired voltage level by setting the resistor ratio of the respective voltage divider accordingly. Thus, the voltage levels of the voltage domains may be independently set by independently setting the resistor ratios of the voltage dividers 235-1 to 235-4. The resistor ratio of a voltage divider may be precisely set, for example, by trimming the resistors of the voltage divider.

When the controller 270 disables one or more of the voltage domains, the feedback voltages V_{FB1} to V_{FB4} of the disabled voltage domains do not contribute to the average feedback voltage V_{FB}. This is because the feedback switches 255-1 to 255-4 of the disabled voltage domains are turned off (open), which isolates the voltage dividers 235-1 to 235-4 of the disabled voltage domains from the common feedback node 260.

In addition, the output of the amplifier 220 does not drive the gates of the pass transistors M₁ to M₄ of the disabled voltage domains. This is because the second gate switches 240-1 to 240-4 of the disabled voltage domains are turned off (open), thereby isolating the gates of the pass transistors M₁ to M₄ of the disabled voltage domains from the output of the amplifier 220. In this case, the amplifier 220 drives the gates of the pass transistors M₁ to M₄ of the enabled voltage domains in a direction that forces the average feedback voltage of the enabled voltage domains to be approximately equal to V_{REF}.

Further, the pass transistors M₁ to M₄ of the disabled voltage domains are turned off, thereby decoupling the disabled voltage domains from the input supply voltage VDDIN. This is because the first gate switches 230-1 to 230-4 of the disabled voltage domains are turned on. As a result, the first gate switches 230-1 to 230-4 of the disabled voltage domains pull the gates of the respective pass transistors M₁ to M₄ to VDDIN, thereby turning off the respective pass transistors M₁ to M₄. Since the disabled voltage domains are decoupled from VDDIN, the disabled voltage domains are allowed to collapse to ground.

Thus, the LDO regulator 210 supports multiple independently-collapsible voltage domains. This significantly reduces power consumption compared to using separate LDOs for the voltage domains. Further, the LDO regulator 210 does not require separate head switches for independently enabling/disabling the voltage domains. This is because the pass transistors M₁ to M₄ of the LDO regulator 210 are used to independently enable/disable the voltage domains. In other words, the pass transistors M₁ to M₄ perform the functions of head switches, eliminating the need for separate head switches. As a result, the voltages at the LDO outputs do not have to be increased to account for IR drops in separate head switches.

FIG. 2 shows an example of four voltage domains. However, it is to be appreciated that the present disclosure is not limited to this example. In general, the LDO regulator 210 may be configured to provide regulated voltages for two, three or more than four voltage domains. For each voltage domain, the LDO regulator may include a first gate switch, a second gate switch, a pass transistor, a voltage divider, a feedback switch, and an averaging resistor.

As shown in FIG. 2, the LDO regulator 210 uses a single feedback loop to regulate the voltage levels of the different voltage domain. This may cause cross regulation, in which ripple or other noise at one voltage domain is coupled to the other voltage domains. For example, a current load transient at one voltage domain may cause the voltage level of the one voltage domain to droop. The voltage droop may be fed back to the amplifier 220, causing the amplifier 220 to adjust the voltage levels of the other voltage domains in response to the voltage droop. As a result, the voltage droop at the one voltage domain may disturb the other voltage domains.

The averaging resistors R_{AVG1} and R_{AVG4} reduce the cross regulation. This is because the averaging resistors R_{AVG1} and R_{AVG4} average the feedback voltages V_{FB1} to V_{FB4} of the voltage domains to generate the feedback voltage V_{FB} input to the amplifier 220. The averaging reduces the impact of ripple or other noise at a single voltage domain on the feedback voltage V_{FB}, and hence the other voltage domains. In certain aspects, one of the voltage domains may tend to be noisier than the other voltage domains. For instance, the noisier voltage domain may be coupled to a circuit that tends to draw a larger current load than the circuits coupled to the other voltage domains.

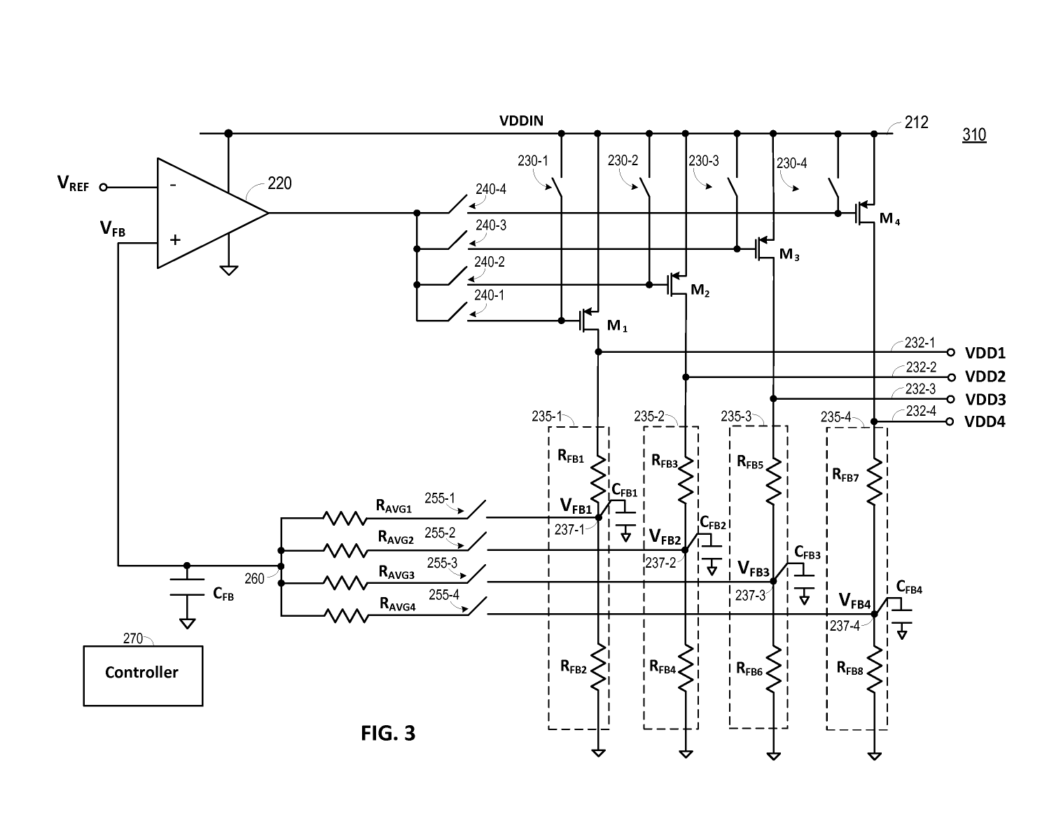

Cross regulation may also be reduced by placing one or more capacitors in the feedback loop of the LDO regulator 210. In this regard, FIG. 3 shows an example in which the LDO regulator 310 further comprising a feedback capacitor C_{FB} coupled to the common feedback node 260. The feedback capacitor C_{FB} and the averaging resistors R_{AVG1} and R_{AVG4} form a low-pass RC filter that attenuates transient noise from one or more of the voltage domains. This reduces the impact of the transient noise on the feedback voltage V_{FB} input to the amplifier 220, and hence the other voltage domains. The capacitance of the feedback capacitor C_{FB} may be chosen so that the cutoff frequency of the low-pass RC filter substantially attenuates transient noise of interest.

As shown in FIG. 3, the LDO regulator 310 may further comprise feedback capacitors C_{FB1} to C_{FB4} coupled to respective feedback nodes 237-1 to 237-4 of the voltage dividers 235-1 to 235-4. The feedback capacitors C_{FB1} to C_{FB4} provide additional poles in the feedback loop of the LDO regulator 310 to attenuate transient noise from one or more of the voltage domains. Although FIG. 3 shows an example in which a feedback capacitor is coupled to each of the feedback nodes 237-1 to 237-4, it is to be appreciated that the present disclosure is not limited to this example. For instance, if one of the voltage domains tends to be noisier than the other voltage domains, then the LDO regulator 310 may comprise just one of the feedback capacitors C_{FB1} to C_{FB4} corresponding to the noisy voltage domain. In general, the LDO regulator 310 may comprise feedback capacitors for any subset of the voltage domains.

In the example shown in FIG. 2, the gate of each of the pass transistors M₁ to M₄ may have a capacitive load that is seen at the output of the amplifier 220 when the respective first gate switch 240-1 and 240-4 is closed. As a result, the total capacitive load seen at the output of the amplifier 220 may change when a voltage domain is enabled or disabled by the controller 270. For example, when a voltage domain is enabled, the capacitive load of the gate of the respective pass transistor is added to the total capacitive load seen by the output of the amplifier 220, and, when a voltage domain is disabled, the capacitive load of the gate of the respective pass transistor may disappear from the total capacitive load seen by the output amplifier 220. The changes in the capacitive load seen at the output of the amplifier 220 when one or more voltage domains are enabled and/or disabled may adversely change the loop dynamics of the LDO regulator 210, and even cause instability in the LDO regulator 210 in a worst case.

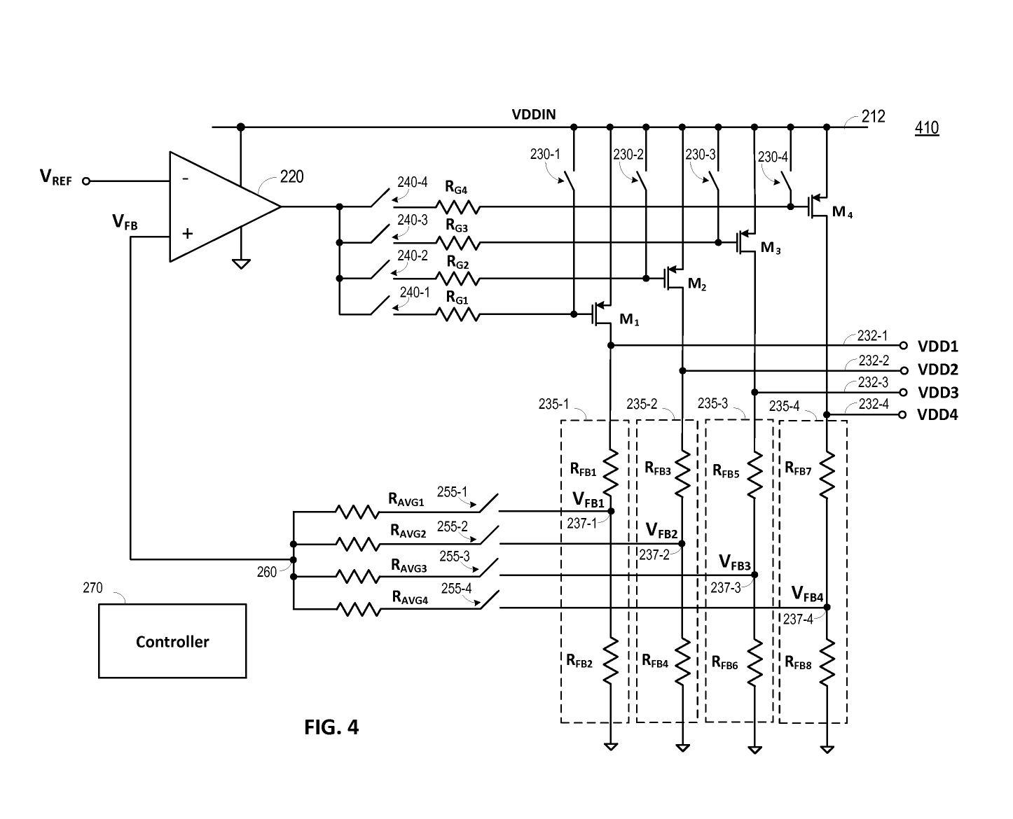

To address this, gate resistors may be coupled to the gates of the pass transistors M₁ to M₄ to substantially mask their capacitive loads from the output of the amplifier 220. In this regard, FIG. 4 shows an LDO regulator 410 according to certain aspects, in which the LDO regulator 410 further comprises a plurality of gate resistors R_{G1} to R_{G4}. Each of the gate resistors R_{G1} to R_{G4} is coupled between the gate of a respective one of the pass transistors M₁ to M₄ and the respective one of the first gate switches 240-1 to 240-4, as shown in FIG. 4. Each of the gate resistors R_{G1} to R_{G4} is configured to substantially mask the capacitive load of the gate of the respective pass transistor from the output of the amplifier 220. This reduces load changes at the output of the amplifier 220 when one or more voltage domains are enabled and/or disabled by the controller 270, thereby reducing changes in the loop dynamics of the LDO regulator 410.

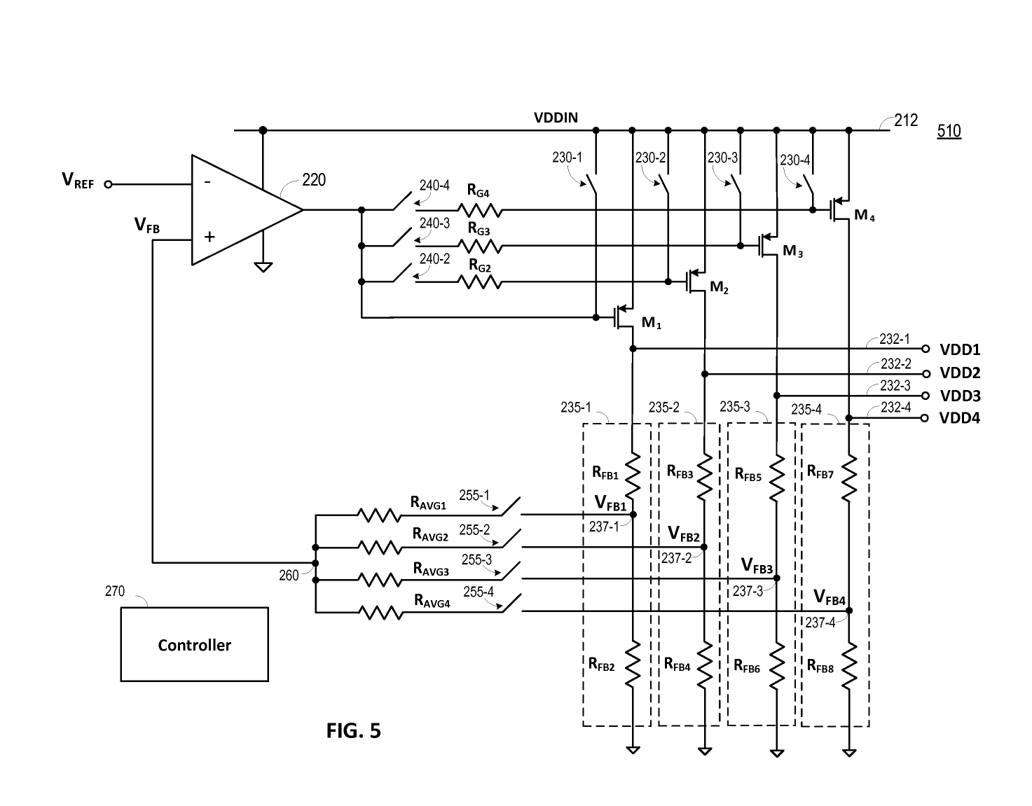

In certain aspects, one of the voltage domains may always be on when the LDO regulator is enabled. For example, FIG. 5 shows an example of an LDO regulator 510 in which voltage domain VDD1 is always on when the LDO regulator 510 is enabled. In other words, there is no use case in this example where voltage domain VDD1 would be disabled while one or more of the other voltage domains VDD2 to VDD4 are enabled. In this example, the gate of the pass transistor M₁ corresponding to the first voltage domain VDD1 may be directly coupled to the output of the amplifier 220 without second gate switch 240-1 and gate resistor R_{G1} shown in FIG. 4. Second gate switch 240-1 is not needed in this example since the first voltage domain VDD1 is always on when the LDO regulator 510 is enabled. Further, gate resistor R_{G1} is not needed. This is because the capacitive load of the gate of pass transistor M₁ is always seen by the output of the amplifier 210 when the LDO regulator 510 is enabled, and therefore does not cause the loop dynamics of the LDO regulator 510 to change during operation of the LDO regulator 510.

In certain aspects, the feedback switch 255-1 corresponding to the always-on voltage domain VDD1 may be omitted. In this case, the feedback node 237-1 of the respective voltage divider 235-1 may be coupled directly to the respective averaging resistors R_{AVG1}.

The LDO regulator 510 may be enabled by turning on the amplifier 220 and disabled by turning off the amplifier 220. In certain aspects, the output of the amplifier 220 may be pulled high when the LDO regulator 510 is disabled to ensure that all of the pass transistors M₁ to M₄ are turned off, and therefore that all of the voltage domains are decoupled from the supply voltage VDDIN. In these aspects, first gate switch 230-1 may be omitted.

It is to be appreciated that aspects of the present disclosure are not limited to the above example. For instance, any one of the other voltage domains VDD2 and VDD4 may always be on when the LDO regulator 510 is enabled instead of or in addition to voltage domain VDD1. In this case, the gate of the pass transistor of the always-on voltage domain may be directly coupled to the output of the amplifier 220.

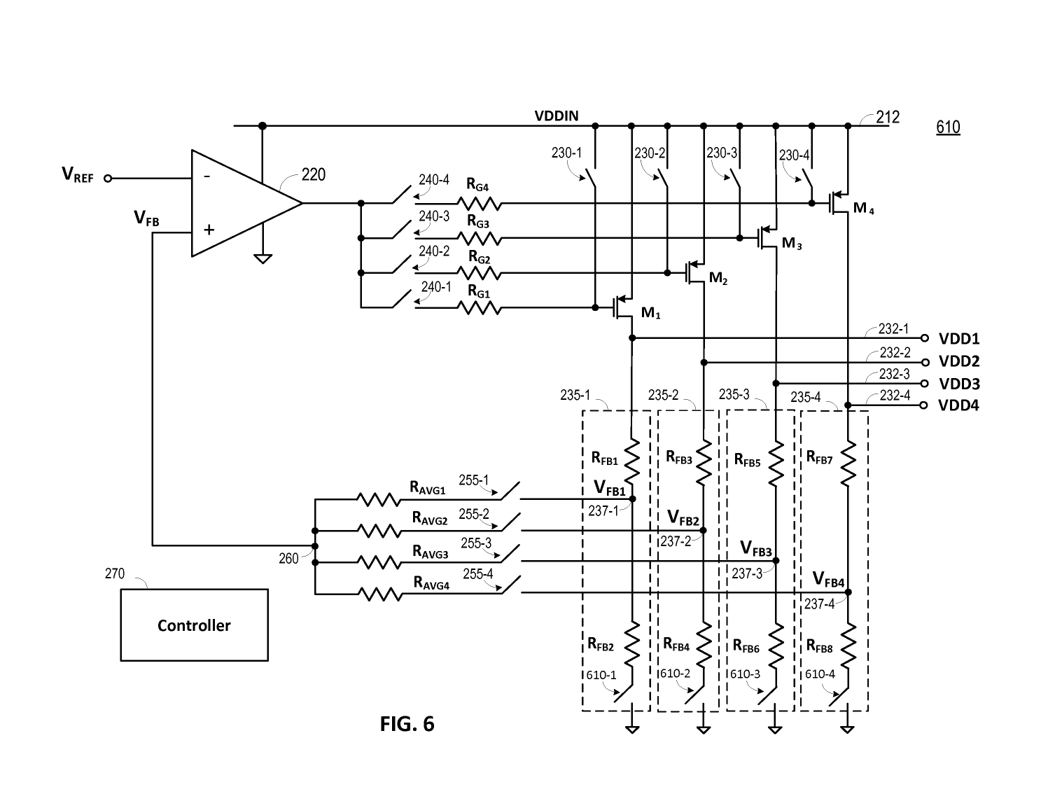

FIG. 6 shows an LDO regulator 610 according to certain aspects, in which the LDO regulator 610 further comprises a plurality of voltage-divider switches 610-1 to 610-4. Each of the voltage-divider switches 610-1 to 610-4 may be coupled between a respective one of the voltage dividers 235-1 to 235-4 and ground. As discussed further below, each voltage-divider switch allows the respective voltage domain to hold charge when the respective voltage domain is disabled by the controller 270.

In operation, when a voltage domain is enabled, the controller 270 may turn on (close) the respective voltage-divider switch, thereby coupling the respective voltage divider to ground. Thus, the operation of the LDO regulator does not change for enabled voltage domains. When a voltage domain is disabled, the controller 270 may turn off (open) the respective voltage-divider switch, thereby decoupling the respective voltage divider from ground. This allows the voltage domain to hold charge by disabling the discharge path through the respective voltage divider to ground. Allowing the voltage domain to hold charge may allow the circuit coupled to the voltage domain to retain logic states and/or reduce the amount of charge needed to re-enable the voltage domain. This assumes that the current leakage of the circuit coupled to voltage domain is relatively low.

It is to be appreciated that aspects of the present disclosure are not limited to the above example. For instance, the LDO regulator 610 may comprise voltage-divider switches for only a subset of the voltage domains instead of all of the voltage domains.

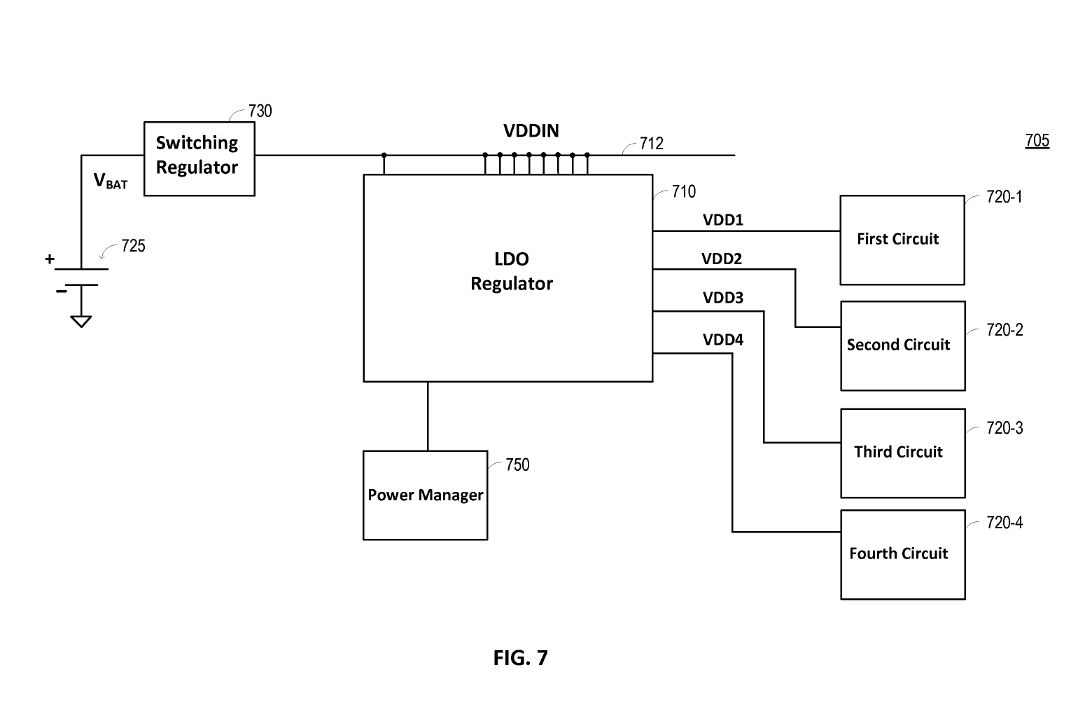

FIG. 7 shows an exemplary system 705 in which an LDO regulator 710 according to certain aspects of the present disclosure may be used. In this example, the LDO regulator 710 is configured to convert input supply voltage VDDIN at supply rail 712 into regulated voltages VDD1 to VDD4 to power circuits 720-1 to 720-4, respectively, in four different voltage domains. The LDO regulator 710 may be implemented using any of the LDO regulators shown in FIGS. 2-6.

In this example, the system 705 may be a battery-powered system (e.g., in a portable device) comprising a battery 725 and a switching regulator 730 coupled between the battery 725 and the LDO regulator 710. The switching regulator 730 may be configured to down convert the voltage V_{BAT} of the battery 725 into the input supply voltage VDDIN. In this example, the switching regulator 730 is used to down-convert the battery voltage V_{BAT} to VDDIN to take advantage of the relatively high efficiency of the switching regulator 730. The LDO regulator 710 is used to convert the supply voltage VDDIN from the switching regulator 730 to the regulated voltages VDD1 to VDD4 used to power the circuits 720-1 to 720-4, respectively. This is because the supply voltage VDDIN from the switching regulator 730 may be too noisy to directly power the circuits 720-1 to 720-4 (e.g., due to switching noise in the switching regulator 720). In this case, the LDO regulated 710 converts the noisy supply voltage VDDIN into relatively steady voltages VDD1 to VDD4 to power the circuits 720-1 to 720-4. Another advantage of using the LDO regulator 710 is that the LDO regulator may allow the voltages VDD1 to VDD4 to be independently set (e.g., by setting the resistor ratios of the respective voltage dividers accordingly), as discussed above. This allows the circuits 720-1 to 720-4 to operate at different voltage levels.

The system 705 also comprises a power manager 750 configured to manage power to the circuits 720-1 to 720-4. For example, the power manager 750 may be configured to power off a circuit when the circuit is not in use to conserve battery life. The power manager 750 may do this by instructing the controller 270 of the LDO regulator 710 to disable the corresponding voltage domain. The power manager 750 may power the circuit back on when the circuit is needed by instructing the controller 270 to re-enable the corresponding voltage domain. Thus, the power manager 750 may independently control power to the circuits 720-1 to 720-4 by instructing the controller 270 to enable/disable the corresponding voltage domains accordingly. If all of the circuits 720-1 to 720-4 are powered off, the power manager 750 may disable the LDO regulator 710, for example, by turning off the amplifier 220 in the LDO regulator 710. The circuits 720-1 to 720-4 may include any types of circuits including, but not limited to, one or more medical sensors, one or more processors, one or more memory devices, one or more analog circuits, or any combination thereof.

In certain aspects, transistors (e.g., metal-oxide-semiconductor field-effect transistors (MOSFETs)) in one or more of the circuits 720-1 to 720-4 may be operated near their threshold voltages. This may be done, for example, by setting the voltage levels of the corresponding voltage domains near the threshold voltages. The voltage levels may be slightly below and/or slightly above the threshold voltages (e.g., below 125% of the threshold voltages). Operating the transistors near their threshold voltages reduces power consumption at the expense of reduced speed. Thus, the transistors may be operated near their threshold voltages in low-power applications where high speed is not required. Another benefit of operating transistors near their threshold voltages is that this reduces current load transients, which, in turn, reduces ripples on the corresponding voltage domains. The smaller voltage ripples reduce the effect of cross regulation between the voltage domains discussed above. Thus, cross regulation may be less of an issue for low-power applications.

It is to be appreciated that aspects of the present disclosure are not limited to the above example. For instance, the switching regulator 730 may be omitted when the battery voltage V_{BAT} is close to the voltages of the voltage domains.

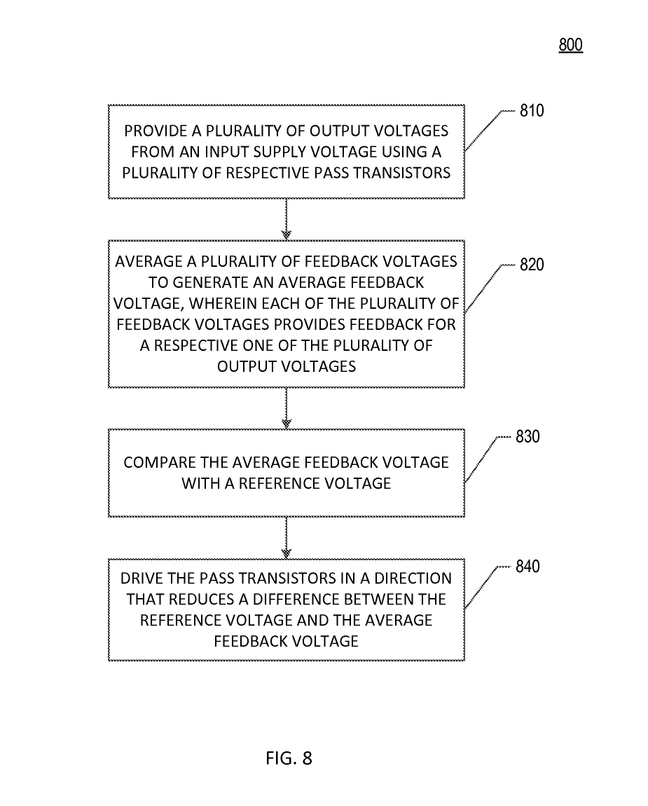

FIG. 8 is a flowchart of a method 800 for voltage regulation according to certain aspects of the present disclosure. The method 800 may be performed by any of the LDO regulators shown in FIGS. 2-6.

At step 810, a plurality of output voltages is provided from an input supply voltage using respective pass transistors. For example, the output voltages (e.g., VDD1 to VDD4) may be provided from the input supply voltage (e.g., VDDIN) to power circuits in different voltage domains.

At step 820, a plurality of feedback voltages are averaged to generate an average feedback voltage, wherein each of the plurality of feedback voltages provides feedback for a respective one of the plurality of output voltages. For example, the feedback voltages (e.g., V_{FB1} to V_{FB4}) may be averaged using averaging resistors (e.g., R_{AVG1} to R_{AVG4}).

At step 830, the average feedback voltage is compared with a reference voltage. For example, the average feedback voltage (e.g., V_{FB}) may be compared with the reference voltage (e.g., V_{REF}) by an amplifier (e.g., amplifier 220).

At step 840, the pass transistors are driven in a direction that reduces a difference between the reference voltage and the average feedback voltage. For example, gates of the pass transistors (e.g., pass transistors M₁ to M₄) may be driven by an amplifier (e.g., amplifier 220) in a direction that reduces the difference between the average feedback voltage and reference voltage at the inputs of the amplifier.

Those skilled in the art would appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. A voltage regulator, comprising:
a plurality of pass transistors, each of the plurality of pass transistors being coupled between an input supply rail and a respective one of a plurality of regulator outputs;
a plurality of averaging resistors configured to average a plurality of feedback voltages to generate an average feedback voltage, wherein each of the plurality of feedback voltages provides voltage feedback for a respective one of the plurality of regulator outputs; and
an amplifier having a first input coupled to the average feedback voltage, and a second input coupled to a reference voltage, wherein the amplifier is configured to drive the plurality of pass transistors in a direction that reduces a difference between the reference voltage and the average feedback voltage.

2. The voltage regulator of claim 1, further comprising a plurality of voltage dividers, wherein each of the voltage dividers is configured to divide a voltage of a respective one of the plurality of regulator outputs into a respective divided voltage, and each of the plurality of feedback voltages corresponds to a respective one of the divided voltages.

3. The voltage regulator of claim 2, further comprising at least one feedback capacitor coupled to at least one of the plurality of voltage dividers.

4. The voltage regulator of claim 2, wherein each of the plurality of voltage dividers comprises two resistors coupled in series, and the divided voltage of each of the plurality of voltage dividers is provided by a node located between the respective resistors.

5. The voltage regulator of claim 2, further comprising a plurality of voltage-divider switches, wherein each of the plurality of voltage-divider switches is configured to selectively couple a respective one of the plurality of a voltage dividers to a ground based on a respective control signal from a controller.

6. The voltage regulator of claim 1, further comprising a capacitor coupled between a common node of the averaging resistors and a ground.

7. The voltage regulator of claim 1, wherein each of the pass transistors comprises a p-type metal-oxide-semiconductor (PMOS) transistor having a source coupled to the input supply rail and a drain coupled to the respective one of the plurality of regulator outputs.

8. The voltage regulator of claim 7, wherein the amplifier is configured to drive gates of the pass transistors.

9. The voltage regulator of claim 1, further comprising a plurality of gate switches, wherein each of the plurality of gate switches is coupled between the input supply rail and a gate of a respective one of the plurality of pass transistors.

10. The voltage regulator of claim 1, further comprising a plurality of gate switches, wherein each of the plurality of gate switches is coupled between an output of the amplifier and a gate of a respective one of the plurality of pass transistors.

11. The voltage regulator of claim 1, further comprising a plurality of feedback switches, wherein each of the plurality of feedback switches is configured to control whether a respective one of the plurality of feedback voltages contributes to the average feedback voltage based on a respective control signal from a controller.

12. The voltage regulator of claim 1, wherein at least one of the plurality of averaging resistors has a resistance that is different from a resistance of another one of the plurality of averaging resistors.

13. A method for voltage regulation, comprising:
providing a plurality of output voltages from an input supply voltage using respective pass transistors;
averaging a plurality of feedback voltages to generate an average feedback voltage, wherein each of the plurality of feedback voltages provides feedback for a respective one of the plurality of output voltages;
comparing the average feedback voltage with a reference voltage; and
driving the pass transistors in a direction that reduces a difference between the reference voltage and the average feedback voltage.

14. The method of claim 13, further comprising generating each of the plurality of feedback voltages by dividing the respective one of the output voltages using a respective voltage divider.

15. The method of claim 13, further comprising attenuating transient noise on one or more of the feedback voltages using one or more feedback capacitors.

16. The method of claim 13, further comprising attenuating transient noise on the average feedback voltage using a feedback capacitor.

17. The method of claim 13, further comprising substantially masking gate capacitive loads of one or more of the pass transistors using one or more gate resistors.

18. The method of claim 13, further comprising preventing one of the plurality of feedback voltages from contributing to the average feedback voltage when a voltage domain corresponding to the respective one of the output voltages is disabled.

19. The method of claim 13, wherein averaging the plurality of feedback voltages comprising weighing at least one of the plurality of feedback voltages more than another one of the plurality of feedback voltages.

20. An apparatus for voltage regulation, comprising:
means for providing a plurality of output voltages from an input supply voltage;
means for averaging a plurality of feedback voltages to generate an average feedback voltage, wherein each of the plurality of feedback voltages provides feedback for a respective one of the plurality of output voltages;
means for comparing the average feedback voltage with a reference voltage; and
means for driving the means for providing the plurality of output voltages in a direction that reduces a difference between the reference voltage and the average feedback voltage.

21. The apparatus of claim 20, further comprising means for generating each of the plurality of feedback voltages by dividing the respective one of the output voltages.

22. The apparatus of claim 20, further comprising means for attenuating transient noise on one or more of the feedback voltages.

23. The apparatus of claim 20, further comprising means for attenuating transient noise on the average feedback voltage.

24. The apparatus of claim 20, further comprising means for substantially masking capacitive loads of the means for providing the plurality of output voltages from the means for driving.

25. The apparatus of claim 20, further comprising means for preventing one of the plurality of feedback voltages from contributing to the average feedback voltage when a voltage domain corresponding to the respective one of the output voltages is disabled.

26. The apparatus of claim 20, wherein the means for averaging the plurality of feedback voltages weighs at least one of the plurality of feedback voltages more than another one of the plurality of feedback voltages.
